(19) United States
(12) Patent Application Publication
(10) Pub. No.: US 2015/0206180 A1
(43) Pub. Date: Jul. 23, 2015

(54) SYSTEMS AND METHODS OF NODULAR CONTENT SERVING

(71) Applicant: Google Inc., Mountain View, CA (US)

(72) Inventors: Vidya Iyer, Cupertino, CA (US); Dan Halem, San Jose, CA (US); John Fitzpatrick, Los Gatos, CA (US); Manish Gupta, Los Altos, CA (US); Sujata Kosalge, Union City, CA (US); Karen Yao, Los Altos, CA (US); Bhanu Narasimhan, Los Gatos, CA (US)

(73) Assignee: Google Inc., Mountain View, CA (US)

(21) Appl. No.: 14/052,174

(22) Filed: Oct. 11, 2013

Related U.S. Application Data
(63) Continuation-in-part of application No. 13/836,879, filed on Mar. 15, 2013.
(60) Provisional application No. 61/713,229, filed on Oct. 12, 2012.

(51) Int. Cl. G06Q 30/02

(52) U.S. Cl. CPC G06Q 30/0251

(57) ABSTRACT

Systems and methods of the present disclosure are directed generally to serving content items via a hierarchical content node structure. More specifically, systems and methods of the present disclosure facilitate generating several content nodes using content data (e.g., bids, budget, content items, keywords, etc.), organizing the content nodes in a custom hierarchy that includes the content nodes, and selecting a content item of a content node to provide as a candidate for display on a user device.

### CROSS-REFERENCE TO RELATED APPLICATIONS

This application claims the benefit of U.S. patent application Ser. No. 13/836,879, titled “DYNAMIC CONTENT ITEM,” Mar. 15, 2013, which claims the benefit of U.S. Patent Application No. 61/713,229, titled “DYNAMIC CONTENT ITEM CREATION,” filed Oct. 12, 2012, which are incorporated herein by reference.

### BACKGROUND

In a networked environment such as the Internet, web publishers such as people or companies can provide information for display on web pages or other documents. The web pages can include text, video, or audio information provided by the entities via a web page server for display on the internet. Content providers, such as third party advertisers, can provide additional content for display on the web pages together with the information provided by the web publishers. A content selection server may select certain additional content to display on a rendering of a web page based on various factors including, e.g., content selection criteria associated with the content to be displayed. Thus, a person viewing a web page can access the information that is the subject of the web page, as well as selected third party content that may appear with the web page.

### SUMMARY

Systems and methods of the present disclosure are directed generally to serving content items via a hierarchical content node structure. More specifically, systems and methods of the present disclosure facilitate generating several content nodes using content data (e.g., bids, budget, content items, keywords, etc.), organizing the content nodes in a custom hierarchy that includes the content nodes, and selecting a content item of a content node to provide as a candidate for display on a user device. The content nodes can be arranged in a tree structure, where information that is shared among multiple nodes can be organized higher in the tree structure, and more granular information or selection criteria can be organized in lower nodes. The lower nodes in this content node hierarchy can inherit information from parent (or ancestor) nodes so the content provider does not need to duplicate this information. Further, any content node in the content node hierarchy can be configured to dynamically (or based on a time interval) receive, obtain, or process feed data (e.g., business data, inventory, product data, selection criteria, etc.) from a content provider. Thus, systems and methods of the present disclosure can automatically update a content node hierarchy of a content campaign using feed data received from a content provider.

At least one aspect is directed to a method of nodular content serving via a computer network. The method can include a data processing system receiving, by at least one processor executing on a server, a request for a content item. The request can include a first attribute and a second attribute. The method can include the data processing system identifying a hierarchical content node structure. The hierarchical content node structure includes a first content node and a second content node, where the second content node inherits distribution parameters from the first content node. The method can include the data processing system determining, using feed data from a content provider, a value for a variable distribution parameter of the second content node (e.g., a numerical value related to a bid for an online content item auction). The method can include the data processing system modifying, based on the value of the variable distribution parameter of the second content node to generate a modified variable distribution parameter (e.g., a modified bid value). The method can include the data processing system matching the first content node with the first attribute of the request. For example, the first content node can include a first distribution parameter, which may include a positive parameter and a negative parameter. The data processing system can match the first distribution parameter (e.g., a selection criteria such as a keyword “hotel”) with an attribute (e.g., a keyword “hotel” associated with the request for content). Responsive to matching the first content node, the method can include the data processing system matching the second content node with the second attribute of the request for content. The data processing system can match the second distribution parameter of the second node (e.g., a geographic location for a hotel, such as Las Vegas) with the second attribute of the request (e.g., a geographic location associated with the request for content, such as Las Vegas). The second distribution parameter of the second node can include parameters inherited from the first node (e.g., the negative parameter or positive parameter). The method can include the data processing system providing a content item of the second content node as a candidate for display on a user device.

In one implementation, the first node and the second node each include at least one of a content item, keyword and bid value. The method can include the data processing system providing, to the second content node, a subset of the first distribution parameters such that the second content node is inheriting the subset of the first distribution parameters. In one implementation, the second content node can inherit the positive parameter from the first content node.

In some implementations, the method includes the data processing system comparing the positive parameter with a second positive parameter of the second content node to determine that the positive parameter and the second positive parameter correspond to a same parameter type. The method can include the data processing system overriding, for the second content node, the positive parameter with the second positive parameter of the second content node.

In some implementations, the method includes the data processing system receiving, from the content provider, feed data including bid adjustment data. The method can include using the bid adjustment data to determine the value for the variable. In one implementation, the bid adjustment data includes at least one of business profit data, performance data, and product inventory data.

In some implementations, the method includes a data processing system determining, based on a first rule and feed data, a first bid amount for the second content node. The method can include the data processing system determining, based on a second rule and feed data, a second bid amount for a third content node. The third content can have the same granularity as the second content node (e.g., be the same level in a hierarchical content node structure or have the same parent node as the second content node). The second bid amount can be larger than the first bid amount. The method can include the data processing system selecting, responsive to the second bid amount being larger than the first bid amount, a content item of the third content node as the candidate for display on the user device.

In one implementation, the method includes the data processing system determining, using the feed data, a third distribution parameter. The third distribution parameter can have increased granularity as compared to the first and second distribution parameters (e.g., Las Vegas is more granular than Nevada, which is more granular than United States). The method can include the data processing system generating, based on the feed data from the content provider, a third content node of the hierarchical content node structure. The third content node includes the third distribution parameter and a second content item. The third content node can also inherit at least a subset of the first and second distribution parameters.

In one implementation in which the request includes a third attribute, the method can include the data processing system identifying a third content node of the hierarchical content node structure. The data processing system can identify the third content node responsive to, or after, matching the second content node. The method can include the data processing system determining that the third attribute does not match a third distribution parameter of the third content node, where the third content node can include at least one distribution parameters inherited from the first content node and the second content node. The method can further include the data processing system providing the content item of the second content node as the candidate for display on the user device. The data processing system can provide the content item response to determining that the second content node corresponds to a lowest matching content node of the hierarchical content node structure.

At least one aspect is directed to a system for nodular content serving via a computer network. The system can include a data processing system having at least one processor. The data processing system can be configured to receive a request for a content item. The request can include a first attribute and a second attribute. The data processing system can be configured to identify a hierarchical content node structure comprising a first content node and a second content node. The second content node can inherit distribution parameters of the first content node. The data processing system can determine, using feed data from a content provider, a value for a variable distribution parameter of the second content node (e.g., a numerical value related to a bid for an online content item auction). The data processing system can modify, based on the value, the variable distribution parameter of the second content node to generate a modified variable distribution parameter (e.g., a modified bid value). The data processing system can be configured to match the first content node with the first attribute of the request. The first content node can include a first distribution parameter, which can include at least one of a positive parameter and a negative parameter. The data processing system can be configured to match the second content node with the second attribute of the request. The second content node can include a second distribution parameter, a subset or all of which can match at least a portion the second attribute. The data processing system can match the second content node with the second attribute response to, or after, the data processing system matches the first content node with the first distribution parameter. The data processing system can provide a content item of the second content node as a candidate for display on a user device.

At least one aspect is directed to a non-transitory computer-readable storage medium that includes processor executable instructions for nodular content serving via a computer network. The instructions can include instructions to receive a request for a content item. The request can include a first attribute and a second attribute. The instructions can include instructions to identify a hierarchical content node structure comprising a first content node and a second content node. The second content node can inherit distribution parameters of the first content node. The instructions can include instructions to determine, using feed data from a content provider, a value for a variable distribution parameter of the second content node (e.g., a numerical value related to a bid for an online content item auction). The instructions can include instructions to modify, based on the value, the variable distribution parameter of the second content node to generate a modified variable distribution parameter (e.g., a modified bid value). The instructions can include instructions to match the first content node with the first attribute of the request. The first content node can include a first distribution parameter, which can include at least one of a positive parameter and a negative parameter. The instructions can include instructions to match the second content node with the second attribute of the request. The second content node can include a second distribution parameter which, a subset or all of which can match at least a portion the second attribute. The instructions can include instructions to match the second content node with the second attribute response to, or after, the data processing system matches the first content node with the first distribution parameter. The second content node can further include a parameter inherited from the first node (e.g., a positive or negative parameter). The instructions can include instructions to provide a content item of the second content node as a candidate for display on a user device.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is an illustration of one implementation of a system for nodular content serving via a computer network.

FIG. 2 is an illustration of one implementation of a hierarchical node structure.

FIG. 3 is an illustration of one implementation of a hierarchical node structure.

FIG. 4 is an illustration of one implementation of a hierarchical node structure.

FIG. 5 is an illustration of one implementation of a method of nodular content serving via a computer network.

FIG. 6 is a block diagram illustrating a general architecture for a computer system that may be employed to implement various elements of the systems and methods described herein, in accordance with an implementation.

Like reference numbers and designations in the various drawings indicate like elements.

### DETAILED DESCRIPTION

Systems and methods of the present disclosure relate generally to a framework for allowing a content provider to organize content items (e.g., advertisements, documents, web pages, images, text, articles, multimedia, etc.) using hierarchical nodes. Content platforms (e.g., advertising platforms) can organize content data into a two-level hierarchy, e.g., content campaigns and content groups, where content campaigns can be associated with a single idea or theme and include a plurality of content groups that can include a set of keywords, advertisements, placements and bids.

Content providers may like to generate a content distribution strategy (e.g., bids, budgets, content items, keywords, branding, promotions, etc.) that is based on their business strategy (e.g., products or services the content provider sells). However, if a content provider has a large amount of business data, it may be challenging to scale a content distribution strategy across all the different offerings of the content provider, let alone keep the content distribution strategy synchronized with the content provider's business strategy as the offerings (e.g., products or services) change over time.

Systems and methods of the present disclosure allow a content provider (or data processing system) to set up a plurality of hierarchical nodes that facilitate aligning a content deliver strategy (e.g., an advertisement strategy) with a business strategy. In one implementation, each node includes a single campaign group. In an illustrative implementation, a top node can target a geographic region such as the United States, keyword hotels and negative keyword foo, and serve a generic hotel advertisement. A child node of the top or parent node can include a keyword beach, geographic region Los Angeles, serve an advertisement for a hotel in Los Angeles, and further add negative keyword sharks. In one implementation, negative selection criteria can be accumulated and inherited throughout the tree, while node specific advertisements or positive targeting override that entire dimension (e.g., advertisements, keywords, geo, feeds, bidding strategy, budgets, status, dates).

In one implementation, the advertiser can provide business data (e.g., feed data) which the system can use to form a tree structure. For example, the business data may include data for hotels and include, for each hotel, a hotel name, city, country, brand, and category. Using this information, the system can generate a node structure where a top node may include general hotels, child nodes may include budget hotels and luxury hotels, a grandchild node may include hotels in Thailand, and great-grandchild node may include hotels in Bangkok. Each node may be associated with one or more keywords, geo, advertisements, and bid values or bid multipliers.

In operation, a data processing system or content selection server can receive a request for content, where the request includes one or more attributes. The data processing system can walk through the nodes to identify a node that matches one or more of the attributes (e.g., semantic or topical similarity). The data processing system can select the lowest or most granular node, which may refer to the node that matches the most attributes of the content request.

In one implementation, dynamic data is obtained via business feeds from content providers. The dynamic data can update or modify one or more distribution parameter of the content node (e.g., a bid value), or a value of a content item (e.g., text or numbers of the content item such as a percent discount). The content node or content items of the content node can include one or more variables that act as placeholders for information that will be inserted prior to selection or delivery of the content item. In one implementation, content information inserted into the content item can be selected based on one or more user attributes associated with a user to whom the content item will be presented. For example, the content information that is inserted into a content item that is provided to a male user from Atlanta may differ from the content information that is provided to a male user from New York. The user attributes may be included in the content item request and/or obtained from a user profile that the user has created.

In an illustrative implementation, an advertiser that advertises for hotels may provide a feed of business data that includes a profit for each hotel. The advertiser can configure a node of the hierarchical content node structure to include a rule or modifier for a bid value such as bid=hotel.profit*0.10. Thus, when the advertiser updates the profit for their hotels, the system can accordingly update the bids as well.

This hierarchical content node structure can further enable advertisers to easily change their bids for particular situations. For example, the hotel advertiser may want to bid higher for hotels when the query is coming from a desperate searcher looking for a hotel in a city they just arrived in. A heuristic representation of such a query may be “hotels in city X”, that originate from city X, on a mobile device. The hotel advertiser can generate, using the systems and methods of the present disclosure, a parent node with general targeting information and advertisements, and can further generate a child node with the above configuration and a bid multiplier increasing bids for this situation. Since child nodes inherit properties of a parent or ancestor node, the advertiser can generate a child node with narrow selection criteria or distribution parameters without having to recreate an entire content campaign or content group.

Further, the systems and methods of the present disclosure can facilitate generating statistic reports for a node or for the subtree of nodes originating at a specific node. The structure of the tree (e.g., hierarchical content node structure) matches the advertiser's internal structure, thus generating a report in a format that is similar to the advertiser's internal business structure.

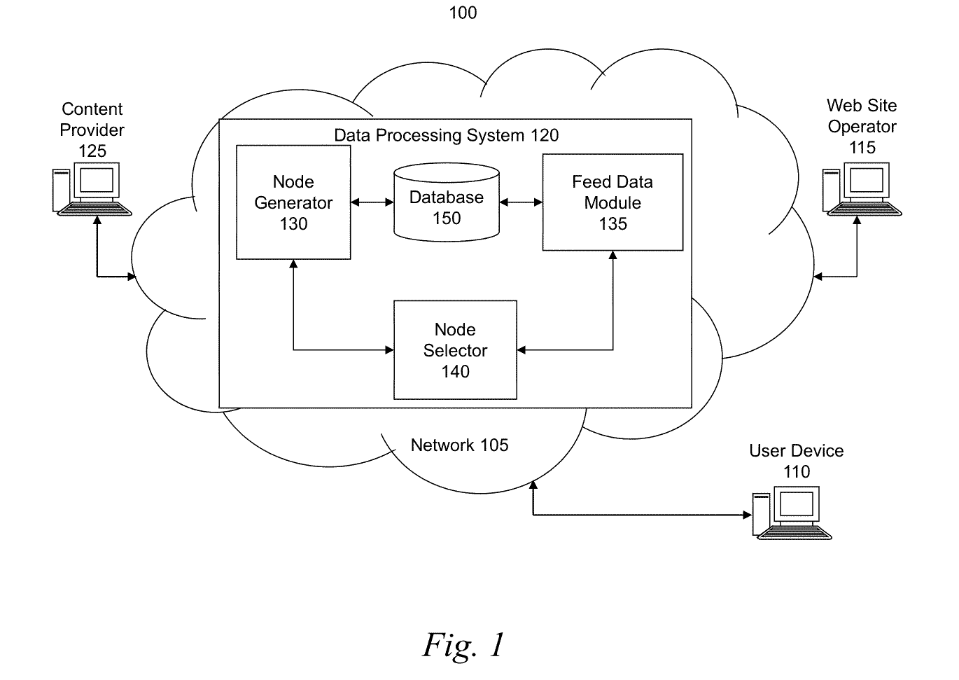

FIG. 1 illustrates one implementation of a system 100 for location-based content selection via a computer network such as network 105. The system 100 and its components, such as a data processing system 120, may include hardware elements, such as one or more processors, logic devices, or circuits. The network 105 can include computer networks such as the Internet, local, wide, metro, data, or other area networks, intranets, satellite networks, combinations thereof, and other communication networks such as voice or data mobile telephone networks. The network 105 can be used to access information resources such as web pages, web sites, domain names, or uniform resource locators that can be displayed on at least one user device 110, such as a laptop, desktop, tablet, personal digital assistant, smart phone, mobile computing devices, mobile telecommunication device, wearable computing device, or portable computer. For example, via the network 105 a user of the user device 110 can access web pages provided by at least one web site operator 115. In this example, a web browser of the user device 110 can access a web server of the web site operator 115 to retrieve a web page for display on a monitor of the user device 110. The web site operator 115 generally includes an entity that operates the web page. In one implementation, the web site operator 115 includes at least one web page server that communicates with the network 105 to make the web page available to the user device 110.

Although FIG. 1 shows a network 105 between the user device(s) 110, data processing system 120, content provider 125, and web site operator 115, the user device(s) 110, web site operator 115, content provider 125 and data processing system 125 may be on the same network 105. The network 105 can be a local-area network (LAN), such as a company Intranet, a metropolitan area network (MAN), or a wide area network (WAN), such as the Internet or the World Wide Web. In some implementations, there are multiple networks 105 between the user devices 110 and the data processing system 120, content provider 125, and web site operator 115. In one of these implementations, the network 105 may be a public network, a private network, or may include combinations of public and private networks.

The network 105 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some implementations, the network 105 may include a wireless link, such as an infrared channel or satellite band. The topology of the network 105 may include a bus, star, or ring network topology. The network may include mobile telephone networks utilizing any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). In some implementations, different types of data may be transmitted via different protocols. In other implementations, the same types of data may be transmitted via different protocols.

The system 100 can include at least one data processing system 120. The data processing system 120 can include at least one logic device such as a computing device having a processor to communicate via the network 105, for example with the user device 110, the web site operator 115, and at least one content provider 125. The data processing system 120 can include at least one server. For example, the data processing system 120 can include a plurality of servers located in at least one data center. In some implementations, the data processing system 120 may include multiple, logically-grouped servers and facilitate distributed computing techniques. In one of these implementations, the logical group of servers may be referred to as a server farm or a machine farm. In another of these implementations, the servers may be geographically dispersed. In other implementations, a machine farm may be administered as a single entity. In still other implementations, the machine farm includes a plurality of machine farms. The servers within each machine farm can be heterogeneous—one or more of the servers or machines can operate according to one type of operating system platform.

In one implementation, servers in the machine farm may be stored in high-density rack systems, along with associated storage systems, and located in an enterprise data center. In this implementation, consolidating the servers in this way may improve system manageability, data security, the physical security of the system, and system performance by locating servers and high performance storage systems on localized high performance networks. Centralizing the servers and storage systems and coupling them with advanced system management tools allows more efficient use of server resources.

Management of the machine farm may be de-centralized. In one implementation, one or more servers may comprise components, subsystems and circuits to support one or more management services for the machine farm. In one of these implementations, one or more servers provide functionality for management of dynamic data, including techniques for handling failover, data replication, and increasing the robustness of the machine farm. Each server may communicate with a persistent store and, in some implementations, with a dynamic store.

Server may include a file server, application server, web server, proxy server, appliance, network appliance, gateway, gateway, gateway server, virtualization server, deployment server, secure sockets layer virtual private network (“SSL VPN”) server, or firewall. In one implementation, the server may be referred to as a remote machine or a node.

The data processing system 120, content provider 125, web site operator 115, and user device 110 may be deployed or executed on any type of client or server, or any type and form of computing device, such as a computer, network device or appliance capable of communicating on any type and form of network and performing the operations described herein.

In one implementation, the data processing system 120 includes a content placement system having at least one server. The data processing system 120 can also include at least one node generator 130, at least one feed data module 135, at least one node selector 140 and at least one database 150. In one implementation, the data processing system 120 also includes a logistic regression module 145. The node generator 130, feed data module 135, and node selector 140 can each include at least one processing unit or other logic device such as programmable logic array engine, or module configured to communicate with the database 150. The node generator 130, feed data module 135, and node selector 140 can be separate components, a single component, or part of the data processing system 120.

In some implementations, the data processing system 120 obtains anonymous computer network activity information associated with a plurality of user devices 110. A user of a user device 110 can affirmatively authorize the data processing system 120 to obtain network activity information corresponding to the user's user device 110. For example, the data processing system 120 can prompt the user of the user device 110 for consent to obtain one or more types of network activity information, such as geographic location information. The identity of the user of the user device 110 can remain anonymous and the user device 110 may be associated with a unique identifier (e.g., a cookie).

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether or how to receive content from the content server that may be more relevant to the user. In addition, certain data may be treated in one or more ways before it is stored or used, so that certain information about the user is removed when generating parameters (e.g., demographic parameters). For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

In one implementation, the data processing system 120 receives content or content items from a content provider 125, such as a commercial entity, online retailer, business, advertiser, individual or any entity that wants to provide content for display on a user device 110 via the computer network 105. The content or content items may include, e.g., text, characters, symbols, images, video, audio, or multimedia content. For example, a content item may include an online advertisement, article, promotion, coupon, or product description. In some implementations, the data processing system 120 receives, e.g., via the node generator 130, information to generate a hierarchical nodular structure that includes the content items, distribution parameters, and other variables.

The data processing system 120 may provide the content item to the web page for display in response to receiving a request for content from a computing device such as, e.g., user device 110. In some implementations, the data processing system 120 receives the request via an application executing on the user device 110. For example, a mobile application executing on a mobile device (e.g., smart phone or tablet) may make a request for content. In another example, a web page may request content from the data processing system 120 responsive to a user of a user device 110 visiting the web page.

In some implementations, the request for content includes information that can facilitate content selection (e.g., keywords, search query, topic information, geographic information, entities, historical data, etc.). In some implementations, the data processing system 120 may request information from the user device 110 to facilitate identifying content or selecting content. The data processing system 120 may request or obtain information responsive to receiving a request for content from the user device 110. The information may include information about displaying the content on the user device 110 (e.g., a content slot size or position) or available resources of user device 110 to display or otherwise manipulate the content.

Responsive to a request for content from a web page operator 115, the data processing system 120 provides a content item for display with a web page on a user device 110. A user of the user device 110 may view the content item (e.g., an impression) or may click on or select the content item (e.g., a click). In one implementation, an indication of user interest in the content item may include a click, selection, mouse over, finger gesture, shake motion, voice command, tap, or another indication that indicates user interest in the content item.

The data processing system 120 can select content items for presentation in based on matching attributes between the request and content item or results of an auction. For example, the data processing system 120 can receive bids from content providers and serve the content items associated with the highest bidders (or a combination of bid and the level of matching or other content item score) at the conclusion of the auction. The bids are amounts that the content providers are willing to pay for presentation (or selection) of their content item on web page. For example, a bid can specify an amount that a content provider is willing to pay for each 1000 impressions (e.g., presentations) of the content item, referred to as a CPM bid. Alternatively, the bid can specify an amount that the content provider is willing to pay for a user interaction with (e.g., a click-through of or hovering a pointer over) the advertisement or a “conversion” following user interaction with the advertisement.

A conversion occurs when a user initiates or completes a transaction related to a content item provided with a web page. What constitutes a conversion may vary from case to case and can be determined in a variety of ways. For example, a conversion may occur when a user clicks on a content item, is then referred or directed to a web page, and initiates a purchase on the web page. A conversion can also be defined by a content provider to be any measurable/observable user action such as, for example, downloading a white paper, navigating to at least a given depth of a website, viewing at least a certain number of web pages, spending at least a predetermined amount of time on a website or web page, registering an account on a website, etc. Other actions that constitute a conversion can also be used.

In one implementation, the data processing system 120 includes a node generator 130 designed and constructed to generate hierarchical content nodes for a content provider 125 based on information received from the content provider 125. In one implementation, the data processing system 120 may receive, from the content provider 125, the hierarchical content node structure. The node generator 130 can be configured to generate or store the hierarchical content node structure in one or more data structure types including, e.g., lists, trees, arrays, or sets. In one implementation, selection criteria or distribution parameters can be configured for one or more nodes at each level of the hierarchical content node structure. Accordingly, a content node can include, or be associated with, a content item (e.g., an advertisement), a keyword, bid, budget, geographic location, etc. In one implementation, a content node can include other content nodes that are nested one or more levels deep.

The node generator 130 can generate parent nodes and child nodes. Childs nodes can further have child nodes to create a hierarchical content node structure (or tree). The node generator 130 can configure settings, selection criteria or distribution parameters at each node. Child nodes can be configured to inherit the distribution parameters or selection criteria of the parent node. Thus, a child node need not specify all settings. In one implementation, the settings that a child node does specify can override that same setting (if specified) of the parent. In an illustrative implementation, the node generator 130 can compare the distribution parameters of a parent node with the distribution parameters of a child node to identify one or more setting, selection criteria or distribution parameter types (e.g., a content item, a keyword, bid, budget, geographic location, etc.). The node generator 130 can determine that the parent node includes a first content item and the child node includes a second content item. Responsive to making this determination, the node generator 130 can override the content item distribution parameter of the child node such that the child node does not inherit the first content item of the parent node. Thus, if the child node is selected in response for a request for content at content serving time, the data processing system 120 can provide the second content item of the child node as a candidate for display on a user device 110.

In one implementation, the node generator 130 can vary the inheritance properties of positive criteria and negative criteria. Positive criteria can refer to an attribute a content provider is seeking out in a content request, while negative criteria can refer to attributes that a content provider does not want to seek out in a content request. In an illustrative implementation, a content provider 125 may want to advertise to content requests associated with the keyword Jaguar, but not content requests associated with the keyword animal. Here, the positive distribution parameter may include Jaguar, and the negative distribution parameter may include animal. The node generator 130 can be designed and constructed to propagate negative criteria such that a child node inherits the negative criteria of a parent node. The node generator 130 can be further configured to override positive parameters such that the child node does not inherit positive parameters of a parent node when then child node also specifies a positive distribution parameter of the same type (e.g., a child node may not inherit positive keywords of the parent node if the child node also specifies positive keywords).

In some implementations, the node generator 130 can generate or modify a hierarchical content node structure, one or more content nodes thereof, or content items associated with the content nodes, using feed data obtained, received or determined via a feed data module 135. In one implementation, the data processing system 120 includes a feed data module 135. The feed data module 130 can be designed and constructed to receive feed data (e.g., business feed data) from a content provider 125. In one implementation, the feed data module 135 can receive feed data in real time, on a periodic basis, or an any other interval. In some implementations, a content provider 125 can push feed data to the data processing system 120, while in other implementations, the data processing system 120 may send a request, to a content provider 125, for feed data. In some implementations, a content provider 125 provide, to the data processing system 120, feed data upon identifying a change in feed data. In yet other implementations, the feed data module 135 may monitor feed data of a content provider 125, identify a change in feed data, and then obtain or send a request for feed data. In some implementations, the feed data module 135 may receive a some or all feed data from a content provider 125. The feed data module 135 may receive only the changed feed data, or only the feed data associated with variable distribution parameters of a content noted of a hierarchical content node structure associated with the content provider 125.

The feed data can be created and maintained by the content provider, such that modifying data used to create or modify settings or parameters of a content node can be updated through an update to the feed data. Because multiple different content nodes can be updated or populated with the feed data, the content provider can update the settings or parameters of multiple different content nodes without being required to update each content node individually. For example, assume that two content nodes each include a variable distribution parameter A, and that the content provider would like to have its profits per month, rather than the profits per week, be presented in its content nodes. Here, instead of being required to individually update each of the two content nodes, the content provider can update the feed data to globally (or selectively) change variable distribution parameter A to be associated with the content providers profits per month. When one of the two content nodes are subsequently selected as a candidate for display, the updated feed parameter will be inserted, included, or applied to one or more content item of the content node, such that the content providers profits per month rather than the profits per week will be used, e.g., to set a bid value for the content item in an online content item auction.

The feed data can be manually entered by the content provider 125, or automatically updated from other sources. In an illustrative implementation, an advertiser can create feed data that specifies a number of each type of room that is available in their hotel, and a lowest price for each type of room. The feed data can be further populated using an inventory management system for the hotel advertiser. In this illustrative implementation, the data processing system (e.g., via the feed data module 135) can periodically access the inventory management system to obtain updated availability and pricing information, and update the feed data with the obtained data. If a user receives an advertisement for the hotel advertiser at a first point in time, the advertisement may specify that a particular number of rooms are available at a particular price. However, if the user (or a different user) later receives the advertisement for the hotel advertiser, the advertisement may indicate that fewer rooms are available, and the price may differ relative to that specified in the earlier instance of the advertisement. Thus, feed data can be used to update or modify distribution parameters of a content node (e.g., selection criteria such as geographic location, keywords, bid values) or a content item associated with the content node (e.g., the content item itself or text, numbers, symbols, characters or colors of the content item).

The data processing system 120 can obtain feed data from a variety of sources, including a content provider's database, online documents associated with the content provider, or landing pages for the content items of the content provider. For example, using the network location of a landing page to which a user is redirected in response to interaction with the advertisement, the content item modifier may request the landing page and obtain data, such as a business address or business phone number for the advertiser. This data can be inserted into the feed data 124 and made available for insertion into the advertiser's customizable advertisements. If the advertiser has multiple locations, the list of locations and corresponding contact information can be included in the feed data 124. The advertiser can specify matching functions that cause the information for a location closest to the user be inserted into the customizable advertisement.

In some implementations, feed data can come from sources other than the content provider 125. In an illustrative implementation, a content provider 125 can configure a feed in which current events, topics, news, stock information, current temperature or other atmospheric conditions are specified. The data processing system 120 can obtain that information from an accessible source, such as a weather information source (e.g., a web page that provides current weather conditions for one or more locations).

The feed data module 135 can be configured to obtain, analyze, process or use other feed parameters and/or other information sources to and determine which feed data should be used to populate a customizable content item or set a variable distribution parameter or content selection criteria. In some implementations, the feed data module 135 can use a function or script to compare or analyze feed data to determine whether or how to apply or incorporate the feed data in a content node. In an illustrative implementation, a time of day parameter can be used to specify when content associated with a particular subset of feed data is eligible to be selected for insertion into a customizable content item. Other information can also be provided by other online resources, and used to either populate the feed data or as contextual data for determining which row of the feed data meet the matching functions. This information can be provided by the content provider 125, obtained from a site specified by the advertiser, or identified by crawling resources from which the information is made available to the public. When the feed data are obtained by crawling resources, the crawl can be performed periodically to maintain updated feed data.

In some implementations, the data processing system 120 (e.g., via the node generator 130 and feed data module 135) can generate a nodular content campaign that includes a hierarchical content node structure with a plurality of relational content nodes configured to apply a bid modifier when a combination of distribution parameters match attributes of a content request. In one implementation, the data processing system 120 can convert an existing content campaign and content groups into content nodes, while in other implementations the nodes can be generated based on feed data or other information. In an illustrative implementation, a hotel advertiser may have an existing content group (e.g., a content item associated with one or more selection criteria such as keywords or geographic location). The data processing system 120 can convert the content group, e.g., hotels in city X, into a node that inherits settings or distribution parameters from a parent node, e.g., hotels in countries United States and Asia. The data processing system 120 can be further configured to generate a child node of hotels in city X that includes distribution parameters: geographic location=city X; location option=physical location only; and a bid multiplier of 200% when the content request is associated with a mobile device. If the content provider 125 wants to add an additional distribution parameter to all content nodes, the content provider 125 can indicate the new distribution parameter to a parent node, and the data processing system 125 can propagate the additional or changed keyword throughout the content nodes structure such that content nodes that do not specify other keywords will inherit the additional or changed keyword.

In one implementation, the data processing system 120 (e.g., via the node generator 130 and feed data module 135) can generate this hierarchical node structure using feed data. The node generator 130 can receive and use various types of data structures, feeds, files or streaming data to generate a hierarchical content node structure. The data can be formatted based on a standard or schema, or the data processing system 120 can be configured to parse or otherwise process the data to determine its meaning and generate a node structure. In some implementations, the data processing system 120 can be provide an application programming interface (“API”) configured to allow for bulk upload of feed data. The API can also be configured to allow the update of individual entries, cells, rows, or other field of the feed data.

In one implementation, the data processing system 120 can receive feed data in the form of a table with columns and rows (e.g., a comma separated values (“CSV”) file). In an illustrative implementation for a hotel advertiser that advertises for one or more hotel businesses, the data processing system 120 can receive or obtain the following business data shown in Table 1:

TABLE 1
Illustrative Feed data for a hotel advertiser

| HotelName | City | Country | Brand | Category |
|---|---|---|---|---|
| Hotel_Name_1 | Bangkok | Thailand | Brand_1 | Budget |
| Hotel_Name_2 | Bangkok | Thailand | Brand_2 | Mid-Range |
| Hotel_Name_3 | Tokyo | Japan | Brand_2 | Budget |
| Hotel_Name_4 | Tokyo | Japan | Brand_3 | Luxury |

For each hotel business identifier (e.g., customer identifier or “CID”) or which the advertiser wants to advertise, the advertiser can also provide additional data structures that includes node information (e.g., a Nodes.CSV), advertisement information (e.g., Ads.CSV), and keyword information (e.g., keywords.CSV).

In an illustrative implementation, the nodes file can define a nodular structure using a table with columns as rows as illustrated in Table 2:

TABLE 2
Illustrative Node structure file

| | BD.Parent | BD.Hotel | | | | | Location |
|---|---|---|---|---|---|---|---|
| Node | Node | Name | BD.Country | Budget | Location | MBid Adj | Option |
| Hotels in | | | Thailand | $10,000 | USA; | | |
| Thailand | | | | | Asia | | |
| Hotel | Hotels in | Hotel | | | | | |
| Name 1 | Thailand | Name 1 | | | | | |
| Hotel | Hotels in | Hotel | | | | | |
| Name 2 | Thailand | Name 2 | | | | | |
| Hotel | Bangkok | | | | Bangkok | 200% | Presence |
| name 2 - | Hotel | | | | | | |
| desperate | name 2 | | | | | | |

In the above illustrative table, the node column can include an identifier or name for the node. The node generator 130 can create a node using this name. The parent Node field can be left blank for the top level node, as there is no parent node. The top node can be defined such that the feed data module 135 can only use a part of the feed data (e.g., the business data of Table 1). For example, the content provider may want to structure the nodes around Country, City. To specify the set of values, the data processing system 120 can be configured to receive a set of values (e.g., Country IN {X, Y, Z}) that specifies a delimited list of values in the appropriate column (e.g., country). If only a single value is needed, then only that value appears; otherwise, if there are multiple column criteria, the resulting criteria can be an AND of those column criteria.

The nodes data structure can further include a column for each content selection setting or distribution parameter including, but not limited to, one or more of the following illustrative examples: content distribution network; location; budget; bid option (e.g., cost per click); bid for the node; extensions (e.g., an active link to a web page that is the same or different than the landing page for the content item); mobile bid modifier; languages; location options; content scheduling; and content rotation.

The keywords data structure can define positive or negative keywords to add to each node. In an illustrative implementation, the keywords file can include the node to which the keyword should be added, keyword, bid, destination URL. Table 3 is an illustrative example of a keywords file:

TABLE 3
Illustrative implementation of keywords data structure

| Node | Keyword | Bid | DestURL |
|---|---|---|---|
| Hotel | [<hotel name 1> | $1 | www.example.com/<hotel name 1> |
| Name 1 | reservation] | | |
| Hotel | [<hotel name 1>] | $2 | www.example.com/<hotel name 1> |
| Name 1 | | | |
| Hotel | <otel name 1> | $1 | www.example.com/<hotel name 1> |
| Name 1 | lodging | | |
| Hotel | <hotel name 2> | $5 | www.example.com/<hotel name 2> |
| Name 2 | in Bangkok | | |
| Hotel | Bangkok | $5 | www.example.com/<hotel name 2> |
| Name 2 | <hotel name 2> | | |

The content item data structure can define the content items. In various implementations, the content item data structure can include or contain links or pointers to text content items, images, multimedia content, documents, video, etc. In one illustrative implementation where the content items include text content items, a data structure for the content items can include, but is not limited to, one or more of the following illustrative data fields: node to which the content item belongs; headline; line 1; line 2; and device preference.

The node generator 130, upon processing the feed data, node data, keyword data and content item data, can generate child nodes that inherit settings specified in a parent node or any ancestor node. In one illustrative implementation, a content node can include three legs that link it to data in one of the tables. A first leg may include a selection leg (‘T”), which can include a Boolean function that uses attributes associated with a content request and the columns in the corresponding table or data structure to select candidate rows. A second leg may include a bidding leg (“B”). The bidding leg may include an spreadsheet-style macro configured to compute a bid based on attributes associated with a content request and corresponding data from a table or data structure. A third leg may include a content item leg (“C”). The content item leg may include a printf( ) statement that constructs the content item to be provided to a user device. The content item leg can construct the content item using visible and destination URLs and other data corresponding to a table or data structure.

In an illustrative implementation, the following pseudo code may represent the three legs of a parent node:

T: (table.hotelName contains $context.location);

B: $0.50+$0.05*$stars;

C: (“Best deals on Hotels in % s, only % d rooms left”, $city, $rooms);

In the above illustration, the Boolean logic of the selection leg uses location information associated with a content request (e.g., the location of the user device originating the content request) to determine if the name of the hotel contains the same location. The bidding leg computes a bid based on a hotel rating (e.g., number of stars of the hotel). The content item leg creates a customized content item using feed data or other data to populate fields for the city (e.g., “% s” which is populated using data associated with “$city”) and number of rooms left (e.g., “% d” which is populated using data associated with “$rooms”).

In an illustrative implementation, the following pseudo code may represent a child node named “California”:

T: ($parentmatches && location in ‘CA’)

C: (“Fun in the California Sun at % d start hotel”, $stars);

In the above child node implementation, the child node overrides the child leg and the content item of the parent, while inhering the bidding leg. The selection leg include a Boolean function that will be satisfied if the parent node is a match and if the location associated with the originating user device is California. The content item leg will construct a content item where “% d” is populated with the hotel rating, e.g., number of stars.

Thus, in one implementation, upon receiving a request for content that includes attributes, the data processing system 120 can identify a parent node, execute a Boolean function associated with selection criteria to determine a match, determine a bidding value using feed data information, and construct a content item using feed data. Further, the data processing system 120 may walk through the tree structure to identify a lowest level matching node. The data processing system 120 may identify a child node, and accordingly execute one or more functions based on the distribution parameters associated with the child node, which is based on what distribution parameters are inherited from the parent node and which distributions parameters of the child node are overriding. In the illustrative implementation above, the child node's selection leg Boolean function and custom content item leg are overriding.

In some implementations, the node generator 130 can update or modify a node using a nodular script, API, or other technique that can propagate changes to one or more child nodes. The nodular script can be designed and constructed to add, remove or replace, e.g., a content item, keyword, or other setting of the node. To do so, the node generator 130 can receive from the content provider 125 information about the affected nodes, content items or keyword. The node generator 130 may also receive information about an action to take, such as add, set, remove. The default action, if not specified, may be to add the new parameter or setting. In one implementation, if the content provider's business feed data changes, the data processing system 120 may receive an snapshot of some or all of the content provider's business feed data, along with changes to the nodes, content item, and keyword files.

In one implementation, the data processing system 120 includes a node selector 140 designed and constructed to identify or select a content node in response to a request for content. The node selector 140 can be configured to receive, e.g., via the data processing system 120, attributes associated with a request for content associated with a web site operator 115 or user device 110. The attributes can include, e.g., keywords, topics, geographic location, device type, time of day, or other information that can facilitate content selection. The node selector 140, upon receiving the attributes of the content request, can match the attributes with one or more content nodes of a hierarchical content node structure to identify the lowest level (e.g., most granular) content node that matches the attributes of the content request.

The node selector 140 may identify a hierarchical node structure and match a first node (e.g., a parent node) with an attribute of the content request. For example, the parent node may include distribution parameters: keyword—hotel, geographic location USA and Asia; and the attributes may include a keyword of a search query—hotel, and location of the origin of the request—Bangkok. Upon identifying a matching parent node, the node selector 140 may walk through one or more child nodes to identify the most granular matching node. For example, the content request may further include an attribute for device type—mobile device. The node selector 140 may match the mobile device attribute with a child node that includes a distribution parameter of device type with a value of mobile device.

In one implementation, the node selector 140 can determine that the child node includes a variable distribution parameter, such as a bid multiplier or a rule. In an illustrative implementation, the bid multiplier rule may include “if device type=mobile device, multiply bid amount by 200%”, or “bid amount=business profit×0.1”, etc. In one implementation, the node selector 140 can select the lowest level matching child node, and further update one or more distribution parameter based on the rule (e.g., using the feed data). In some implementations, variable distribution parameters can be updated on a periodic bases, responsive to a content request, in real time, upon request of a content provider, or other time interval.

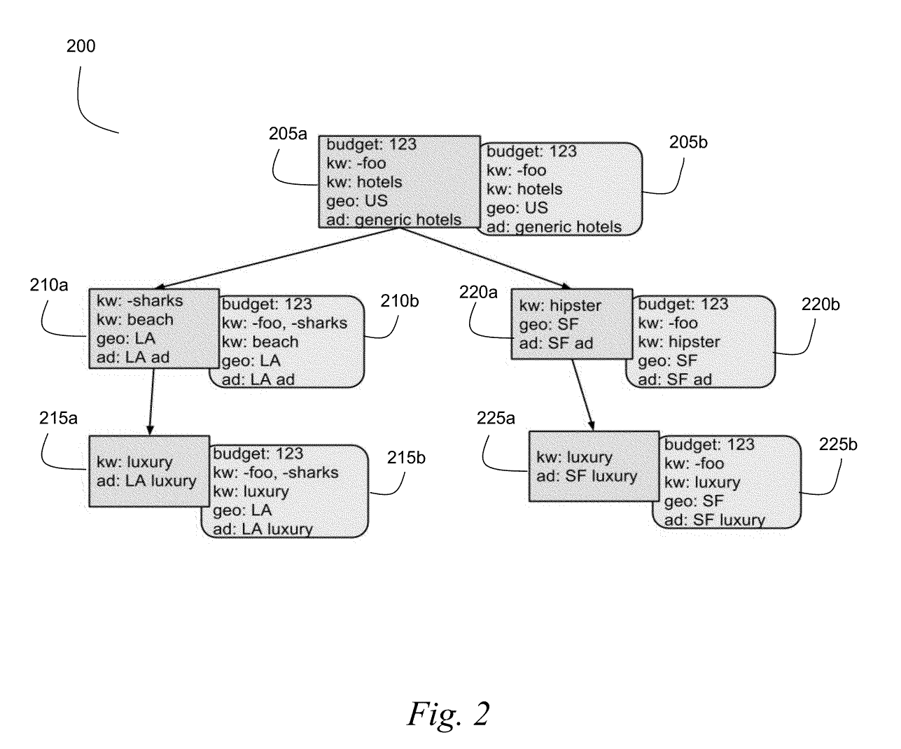

FIG. 2 illustrates an implementation of a hierarchical content node structure 200. In this implementation, the node structure 200 includes a parent node 205, child nodes 210 and 220, and grandchild nodes 215 and 225 linked to child nodes 210 and 220, respectively. In one implementation, a content provider can provide data to a data processing system, and the data processing system can generate the hierarchical content node structure. As shown in this illustrative implementation, a content provider can provide some or all of the data shown in 205a, 210a, 215a, 220a, and 225a. Using this data, the data processing system can generate parent and child nodes that includes the data shown in 205b, 210b, 215b, 220b, and 225b. Each node 205-225 can be a severable entity. A node may include content items, or a node may not include any content items (e.g., a top-level parent node without content items, where the child nodes include the content items). As shown in this implementation, the negative criteria are inherited throughout the tree, and each child node is more granular or specific than its parent node.

Node 205 includes the following distribution parameters: budget 123; negative keyword foo; positive keyword hotels; geographic location United States; and an advertisement for generic hotels. The data processing system can generate the node 205b with these distribution parameters, as this is a parent node without any parameters to be inherited. The parent node 205 can include or be linked to child nodes 210 and 220. Child nodes 210 and 220 can further include or be linked to child nodes 215 and 225, respectively.

In one implementation, a first child node 210a may provide the following distribution parameters: negative keyword sharks; positive keyword beach; geographic location Las Angeles; and an advertisement for Los Angeles. The data processing system can compare these parameters with the parent node 205 to determine a final set of distribution parameters for the child node, where negative parameters are inherited from the parent node 205 and positive parameters of child node 210 override positive parameters of the same type in the parent node 205. In this illustrative implementation, the data processing system inherits the following distribution parameters from parent node 205: budget 123; and negative keyword foo. Since both the parent and the child provided positive keywords and geographic location and a content item, these distribution parameters of the child node 210 will be used to override those of the parent. Thus, the final distribution parameters for the child node include: budget 123; negative keywords foo and sharks; positive keyword beach; geographic location Los Angeles; and an advertisement for Los Angeles.

The child node 215 can further include or be linked to a child node 215 (or “grandchild node”). The grandchild node 215 can provide distribution parameters: positive keyword luxury and an advertisement for Los Angeles luxury. Thus, the grandchild node will inherit, from its parent node 210, all other distribution parameters and negative distribution parameters, while overriding the keyword and content item distribution parameters. The final distribution parameters for grandchild node 215 will include: budget 123; negative keywords foo and sharks; positive keyword luxury; geographic location Los Angeles; and an advertisement for Los Angeles.

Similar to child node 210, the parent node 205 can include or be linked to a second child node 220 that provides distribution parameters for positive keywords, geographic location and content items. The child node 220 can further include a grandchild node 225, which can inherit and override parameters in a similar manner as child node 215.

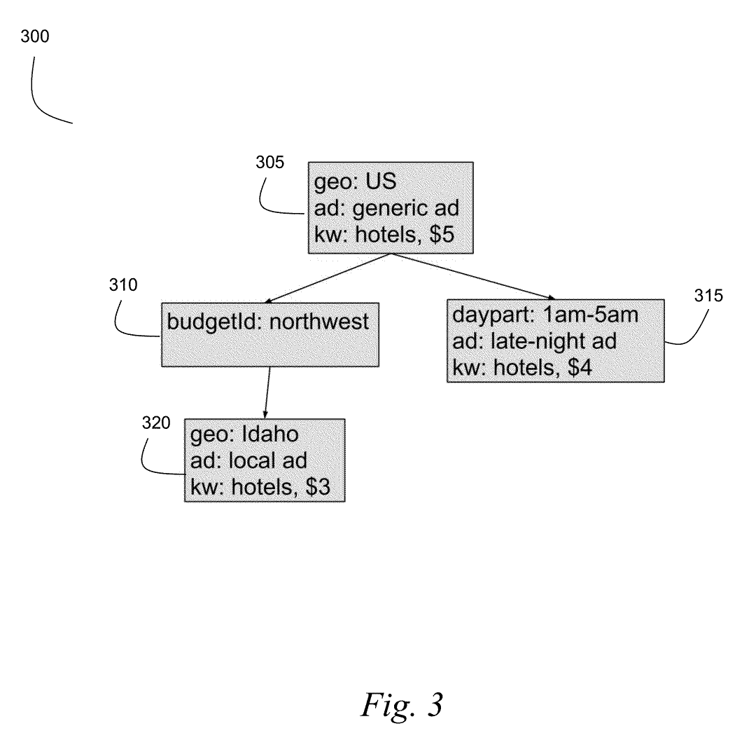

FIG. 3 illustrates an implementation of a hierarchical content node structure 300. In this implementation, the content node structure 300 includes a parent node 305, child nodes 310 and 315, and a grandchild node 320. Parent node 305 includes distribution parameters: geographic location United States; a generic advertisement; and keyword hotel with a keyword bid amount of $5. Child node 310 includes a budget distribution parameter, which identifies the budget associated with the budget identifier northwest. Child node 315 includes distribution parameters: time of day 1 AM-5 AM; a late night advertisement; and keyword hotels with a keyword bid amount of $4. Grandchild node 320, which is a child of child node 310, includes distribution parameters: geographic location Idaho; a local advertisement; and keyword hotel with a keyword score of $3.

In one implementation, a data processing system may receive a request for a content that includes one or more attributes. The data processing system may match the attributes with distribution parameters of the nodes of the node structure to identify the most granular or lowest level node that matches the attributes. In an illustrative implementation, a content request may include attributes of 2 AM and geographic location. In this case, the data processing system may determine that both child node 315 (which includes distribution parameter 1 AM-5 AM) and grandchild node 320 (which includes distribution parameter geographic location Idaho) match the attributes of the content request. In one implementation, the data processing system can select the lowest level node in the tree, which may be grandchild node 320. In one implementation, the data processing system can other selection rules to select the node. In an illustrative implementation, the data processing system can select the node associated with the highest budget, highest or lowest bid amount, or based on other distribution parameter or comparisons of same. The data processing system may determine that the keyword bid amount for hotels is $4 in child node 315 and $3 in grandchild node 320. The data processing system may select the higher bid amount, because it may be more likely to win in an online content item auction, or select the lower bid amount because it may be associated with a more relevant content node which may win the auction with a lower bid amount.

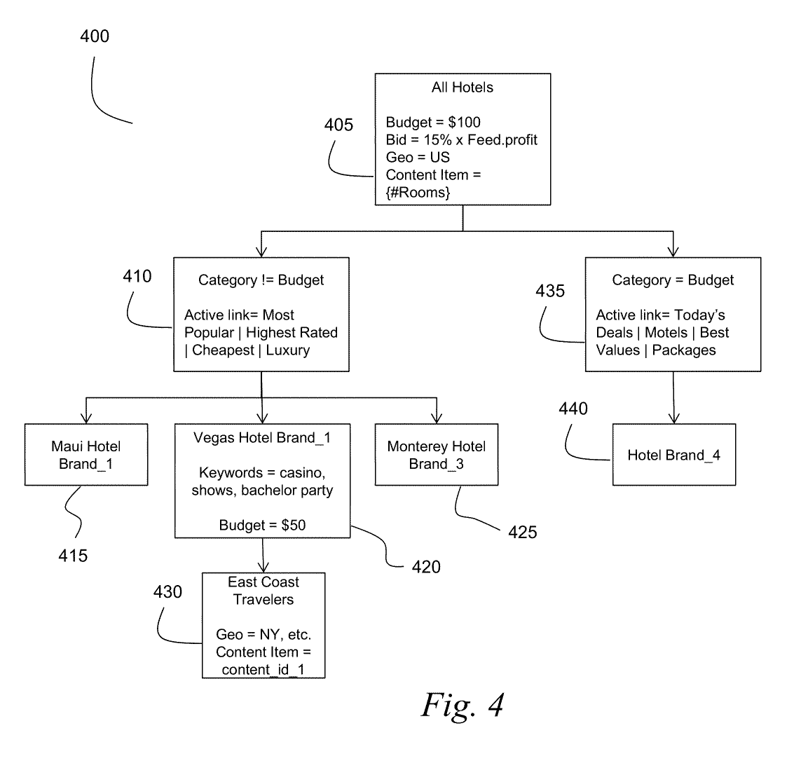

FIG. 4 illustrates another implementation of a hierarchical content node structure 400. The node structure 400 includes parent node 405, child nodes 410 and 435, grandchild nodes 415, 420, 425 and 440, and great grandchild node 430. In one implementation, a data processing system can walk through the nodes to identify the lowest level node matching attributes of a content request, and select a corresponding content item.

Parent node 405 includes distribution parameters for hotels, a budget of $100, a dynamic bid amount associated with feed data (15%×feed.profit), a geographic location of United States, and a dynamic or customizable content item based on feed data (e.g., text of content item can change to indicate the number of rooms remaining in a hotel). From parent node 405, the tree branches off into categories not-budget and budget, that correspond to child nodes 410 and 435 respectively. Child nodes 410 and 415 include an extension, which, in one implementation, can include an active link to a web site. Child node 410 includes an active link to a website corresponding to Most Popular|Highest Rated|Cheapest|Luxury. Child node 415 includes an active link corresponding to Today's Deals|Motels|Best Values|Packages. Active links can dynamically change.

In some implementations, the extension can be configured to causes additional content to be inserted into the content item when extender criteria are met. An advertiser can create sitelinks that can be used to extend an advertisement. A sitelink is content (e.g., text) that includes an active link to a page (e.g., other than the landing page for the advertisement) in the advertiser's site. The inclusion of advertisement extenders, such as sitelinks in an advertisement can be conditioned on extender conditions being met. An advertiser can configure a particular sitelink that redirects a user to one page of the advertiser's site be included in the advertisement when the advertisement will be presented to a person in New York. The advertiser can further specify that a different sitelink that redirects a user to another page of the advertiser's site is to be included in the advertisement when the advertisement will be presented to a person in Atlanta. Inclusion of an advertisement extender can increase the size of an advertisement.

From child node 410, the tree can branch off into grandchild nodes 415, 420 and 425. Grandchild node 415 does not provide additional distribution parameters, so all of its distribution parameters will be inherited from ancestral nodes, such as parent node 405 and child node 410. Since parent node 405 includes distribution parameters based on feed data, the corresponding distribution parameter, when inherited by grandchild node 415, will be modified based on feed data associated with node 415. For example, parent node 405 includes dynamic distribution parameters that include feed data for profit and number of rooms in a hotel. When grandchild node 415 inherits this dynamic distribution parameter, the grandchild node 415 can use feed profit data for Maui Hotel Brand_{—}1, and the number of available rooms in Maui Hotel Brand_{—}1. The data processing system can modify, in a similar manner, one or more inherited dynamic distribution parameters for nodes 420, 425 and 430 and 440.

In some implementations, a data processing system can track performance the node structure on a per node basis and generate a report with performance statistics for each node or a combination of one or more nodes or node structures.

In some implementation, as illustrated in parent node 405, feed data can be used to create a customizable content item. Feed data can include a set of content that is available to be inserted into a customizable advertisement. Each content provider that creates a customizable content item can also create or identify one or more sets of feed data with which customized content items will be created. For example, assume that a particular advertiser sells products online and delivers the products to the buyer. In this example, the advertiser may provide feed data specifying, for multiple different user locations, an estimated delivery date to the user location if ordered by a specified time.

For purposes of illustration, a content provider may deliver products to New York in two days, and can deliver products to Atlanta in three days. In this example, the content provider can create feed data that includes feed data entries for different days of the week on which the content item is presented to users. The feed data table can also include feed data entries that indicate, for each of the days on which the content item is presented to users, when products will be delivered to buyers in Atlanta if the products are ordered on that day. The feed data table can also include feed data entries that indicate, for each of the days on which the content item is presented to users, when products will be delivered to buyers in New York if the products are ordered on that day.

The data processing system (e.g., via a feed data module) can use the feed data entries that are included in the feed data table to create a custom content item to be provided in response to an advertisement request. For example, on a Tuesday, the data processing system may receive a request for content including attributes indicating that the request originated from Atlanta (e.g., based on an Internet Protocol address of the Internet Service Provider or based on data provided by the user). In this example, the data processing system can determine, based on the present day (e.g., the day on which the advertisement request was received) being Tuesday and the user device being located in Atlanta, which feed data entry to use to create the custom content item. In particular, the data processing system can insert the content referenced by the feed data entry into a customizable content item to specify that if products are ordered by the user today, they will be delivered to the user by Friday.

Thus, a content provider can create as few as a single customizable content item (e.g., a content item template) that can be populated with content referenced by feed data entries to create many different customized content items for many different groups of users. A single customizable content item can be populated with content from any number of different feed data entries and the feed data entries that are selected for populating the customizable advertisement can be selected based on criteria specified by the advertiser and/or historical advertisement performance of customizable advertisements that were populated with the content.

The data processing system (e.g., via a feed data module) can use matching function to determine a subset of feed data to select for customizing a content item (e.g., a matching function may be day of the week, time based, geographic location-based, etc.). In some implementations, one or more matching functions may be associated with a content item of a content node. In some implementations, the selection can be based on a specificity of the matching functions. The specificity of a matching function generally increases with the number of attributes that are specified by the matching functions. For example, a first matching function requiring three specific user attributes be specified by the content request will generally be considered more specific than a second matching function requiring only two of the three specific user attributes be specified by the use context data. Thus, when the user context data includes each of the user attributes required by both the first and second matching functions, the first matching function may be used to control which portion of the feed data is used since the first matching function is considered more specific.

The data processing system (e.g., via a feed data module) can use the content referenced by (e.g., stored at) the portion of the feed data specified by the matching function to create a custom content item for the content request. In some implementations, the custom content item is created by inserting the content that is referenced by the portion of the feed data in place of one or more variables (e.g., variable distribution parameters) that are included in a customized content item or content node, thereby modifying the customized content item to create a custom content item. The content referenced by the portion of the feed data that is used to create the custom content item can be referred to as modifying data.

Customizable portions of content items are portions of the customizable content item into which feed data can be inserted to customize the customizable content item. In some implementations, each customizable portion of a customizable content item is associated with (e.g., includes) a variable (variable distribution parameter or another placeholder) for which a value is determined using the feed data. For example, a first customizable portion can include variable A specifying that the modifying data that correspond to variable A are to be inserted in the first customizable portion. Similarly, a second customizable portion can includes variable B specifying that the modifying data that correspond to variable B are to be inserted in the second customizable portion.

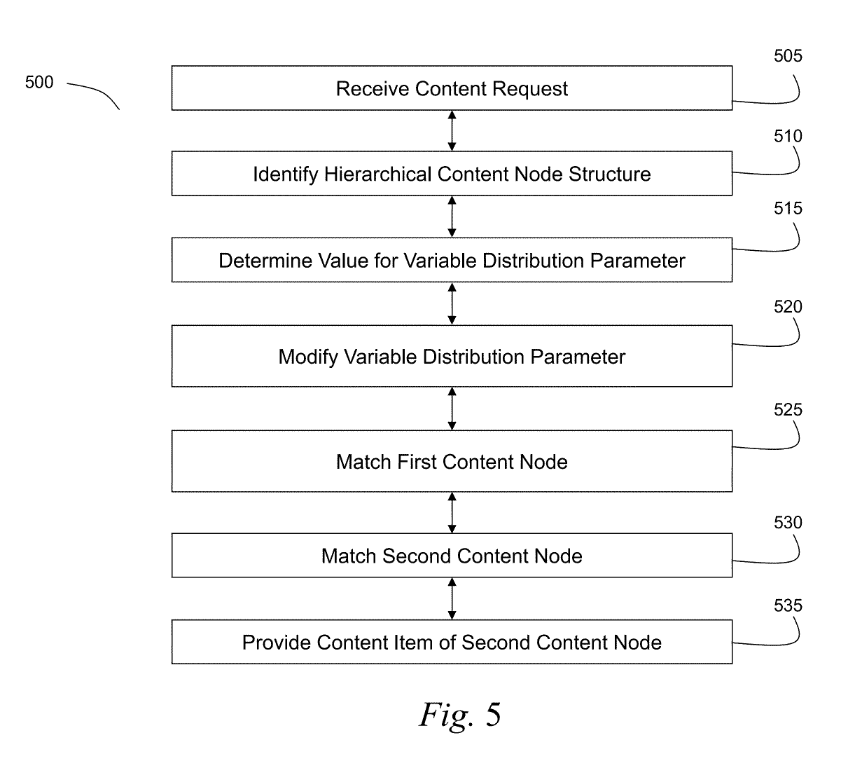

FIG. 5 illustrates an implementation of a method of nodular content serving via a computer network. The method 500 can be performed by a processor executing on a server or a data processing system. In brief overview, the method 500 includes receiving a request for a content item that includes one or more attributes (505). The method 500 can include the data processing system identifying (e.g., via a node selector) a hierarchical content node structure (510). The hierarchical content node structure can includes a first content node and a second content node, where the second content node inherits distribution parameters from the first content node. The method 500 can include the data processing system determining (e.g., via feed data module), using feed data from a content provider, a value for a variable distribution parameter of the second content node (e.g., a numerical value related to a bid for an online content item auction). (515). The method 500 can include the data processing system modifying (e.g., via a node generator or feed data module), based on the value of the variable distribution parameter of the second content node to generate a modified variable distribution parameter (e.g., a modified bid value). (520). The method 500 can include the data processing system (e.g., via a node selector) matching the first content node with the first attribute of the request. (525). For example, the first content node can include a first distribution parameter, which may include a positive parameter and a negative parameter. The data processing system can match the first distribution parameter (e.g., a selection criteria such as a keyword “hotel”) with an attribute (e.g., a keyword “hotel” associated with the request for content). Responsive to matching the first content node, the method 500 can include the data processing system matching the second content node with the second attribute of the request for content. (530). The data processing system can match the second distribution parameter of the second node (e.g., a geographic location for a hotel, such as Las Vegas) with the second attribute of the request (e.g., a geographic location associated with the request for content, such as Las Vegas). The second distribution parameter of the second node can include parameters inherited from the first node (e.g., the negative parameter or positive parameter). The method 500 can include the data processing system providing a content item of the second content node as a candidate for display on a user device. (535).

In some implementation, the data processing system can determine distribution properties for the node structure at content serving time. For example, upon receiving a request for a content item, the data processing system can identify node structure, and then assign distribution properties to the nodes of the node structure. Child nodes may inherit properties of parent nodes, dynamic distribution parameters can be determined based on feed data (which may updated at content serving time or previously obtained based on another time interval).

In one implementation, the data processing system walks through the updated node structure to identify the lowest level matching node. The data processing system may identify a child node as matching, and then attempt to determine if a grandchild node of the child node also matches attributes of the content request. For example, a child node may match two attributes of the content request. The data processing system may then determine whether the grandchild node also matches the attributes of the content request. In one implementation, the grandchild node may not match attributes of the content request, in which case the child node may be the lowest level matching content node. For example, the grandchild node may specify a time of day which may not match the time of the day associated with the content request. In another example, the grandchild node may not match the content request because it includes a negative distribution parameter (e.g., a negative keyword), and the content request may include that keyword. Upon determining that the grandchild node does not match the content request, the data processing system may provide content associated with the child node.

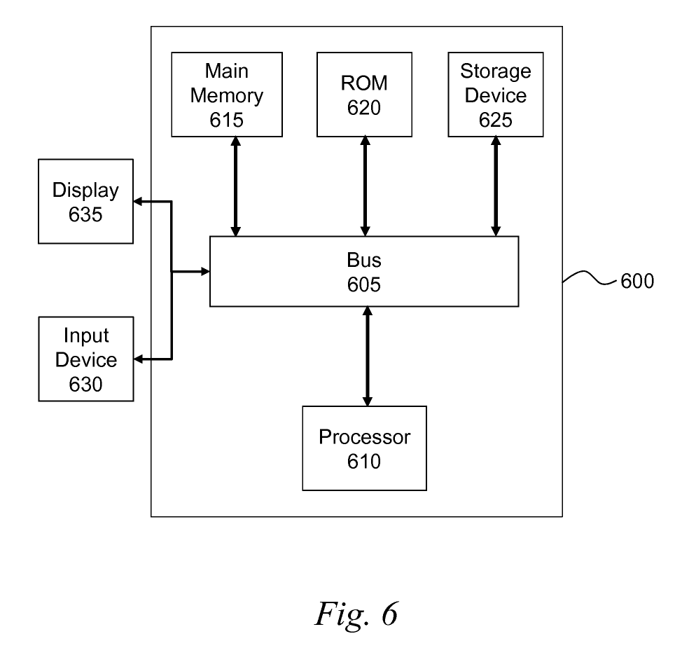

FIG. 6 is a block diagram of a computing system 600 in accordance with an illustrative implementation. The computing system or computing device 600 can be used to implement the system 100, content provider 125, user device 110, web site operator 115, data processing system 120, node generator 130, feed data module 135, and node selector 140 and database 150. The computing system 600 includes a bus 605 or other communication component for communicating information and a processor 610 or processing circuit coupled to the bus 605 for processing information. The computing system 600 can also include one or more processors 610 or processing circuits coupled to the bus for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 620 or other static storage device coupled to the bus 605 for storing static information and instructions for the processor 610. A storage device 625, such as a solid state device, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information and command selections to the processor 610. In another implementation, the input device 630 has a touch screen display 635. The input device 630 can include a cursor control, such as a mouse, a trackball, or cursor direction keys, for communicating direction information and command selections to the processor 610 and for controlling cursor movement on the display 635.

According to various implementations, the processes described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

Although an example computing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources.

The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method of nodular content serving via a computer network, comprising:
receiving, by at least one processor executing on a server, a request for a content item, the request including a first attribute and a second attribute;
identifying, by the server in a memory element, a hierarchical content node structure set up by a content provider, the hierarchical content node structure comprising a first content node and a second content node, the second content node inheriting distribution parameters of the first content node;
determining, by the server at content serving time, using real-time dynamic feed data from the content provider, a value for a variable distribution parameter of the second content node;
modifying, based on the value, the variable distribution parameter of the second content node to generate a modified variable distribution parameter;
identifying, by the server, a first distribution parameter of the first content node, the first distribution parameter including a positive parameter and a negative parameter;
matching, by the server, the first distribution parameter of the first content node with the first attribute of the request based on the first attribute of the request including the positive parameter and not including the negative parameter;
identifying, by the server, a second distribution parameter of the second content node, the second content node including the negative parameter inherited from the first content node and the modified variable distribution parameter;
responsive to matching the first content node, matching, by the server, the second distribution parameter of the second content node with the second attribute of the request based on the second attribute of the request not including the negative parameter inherited from the first content node; and
using, by the server, the modified variable distribution parameter to provide a content item of the second content node as a candidate for display on a user device.

2. The method of claim 1, wherein the first node and the second node each comprise at least one content item, keyword and bid value.

3. The method of claim 1, comprising:
inheriting, by the second content node, a subset of the first distribution parameter.

4. The method of claim 1, comprising:
inheriting, by the second content node, the positive parameter from the first content node.

5. The method of claim 1, comprising:
comparing the positive parameter with a second positive parameter of the second content node to determine that the positive parameter and the second positive parameter correspond to a same parameter type; and
overriding, for the second content node, the positive parameter with the second positive parameter of the second content node.

6. The method of claim 1, comprising:
receiving, from the content provider, feed data including bid adjustment data; and
using the bid adjustment data to determine the value for the variable distribution parameter.

7. The method of claim 6, wherein the bid adjustment data comprises at least one of business profit data, performance data, and product inventory data.

8. The method of claim 1, comprising:
determining, based on a first rule and feed data, a first bid amount for the second content node;
determining, based on a second rule and feed data, a second bid amount for a third content node, the third content node corresponding to a same level as the second content node in the hierarchical content node structure, the second bid amount larger than the first bid amount; and
selecting, responsive to the second bid amount being larger than the first bid amount, a content item of the third content node as the candidate for display on the user device.

9. The method of claim 1, comprising:
determining, by the server, using the feed data, a third distribution parameter, the third distribution parameter having increased granularity as compared to the first and second distribution parameters; and
generating, by the server, based on the feed data from the content provider, a third content node of the hierarchical content node structure, the third content node comprising the third distribution parameter, a second content item and inheriting the first and second distribution parameters.

10. The method of claim 1, wherein the request includes a third attribute, the method comprising:
responsive to matching the second content node, identifying, by the server, a third content node of the hierarchical content node structure;
determining that the third attribute does not match a third distribution parameter of the third content node, the third content node including at least one distribution parameters inherited from the first content node and the second content node; and
responsive to determining, by the server, that the second content node corresponds to a lowest matching content node of the hierarchical content node structure, providing the content item of the second content node as the candidate for display on the user device.

11. A system for nodular content serving via a computer network, comprising:
a data processing system comprising a feed data module and a node selector executing on at least one processor, the data processing system configured to:
receive a request for a content item, the request including a first attribute and a second attribute;
identify, in a memory element, a hierarchical content node structure set up by a content provider, the hierarchical content node structure comprising a first content node and a second content node, the second content node inheriting distribution parameters of the first content node;
determine, at content serving time, using real-time dynamic feed data from the content provider, a value for a variable distribution parameter of the second content node;
modify, based on the value, the variable distribution parameter of the second content node to generate a modified variable distribution parameter;
identify a first distribution parameter of the first content node, the first distribution parameter including a positive parameter and a negative parameter;
match the first distribution parameter of the first content node with the first attribute of the request based on the first attribute of the request including the positive parameter and not including the negative parameter;
identify a second distribution parameter of the second content node, the second content node including the negative parameter inherited from the first content node and the modified variable distribution parameter;
responsive to matching the first content node, match, the second distribution parameter of the second content node with the second attribute of the request based on the second attribute of the request not including the negative parameter inherited from the first content node; and
use the modified variable distribution parameter to provide a content item of the second content node as a candidate for display on a user device.

12. The system of claim 11, wherein the first node and the second node each comprise at least one content item, keyword and bid value.

13. The system of claim 11, wherein the data processing system is further configured to:
compare the positive parameter with a second positive parameter of the second content node to determine that the positive parameter and the second positive parameter correspond to a same parameter type; and
override, for the second content node, the positive parameter with the second positive parameter of the second content node.

14. The system of claim 11, wherein the data processing system is further configured to:
receive, from the content provider, feed data including bid adjustment data; and
use the bid adjustment data to determine the value for the variable.

15. The system of claim 14, wherein the bid adjustment data comprises at least one of business profit data, performance data, and product inventory data.

16. The system of claim 11, wherein the data processing system further configured to:
determine, based on a first rule and feed data, a first bid amount for the second content node;
determine, based on a second rule and feed data, a second bid amount for a third content node, the third content node corresponding to a same level as the second content node in the hierarchical content node structure, the second bid amount larger than the first bid amount; and
select, responsive to the second bid amount being larger than the first bid amount, a content item of the third content node as the candidate for display on the user device.

17. The system of claim 11, wherein the data processing system is further configured to:
determine, using the feed data, a third distribution parameter, the third distribution parameter having increased granularity as compared to the first and second distribution parameters; and
generate, based on the feed data from the content provider, a third content node of the hierarchical content node structure, the third content node comprising the third distribution parameter, a second content item and inheriting the first and second distribution parameters.

18. The system of claim 11, wherein the request includes a third attribute, the data processing system is further configured to:
responsive to matching the second content node, identify a third content node of the hierarchical content node structure;
determine that the third attribute does not match a third distribution parameter of the third content node, the third content node including at least one distribution parameters inherited from the first content node and the second content node; and
responsive to determining, that the second content node corresponds to a lowest matching content node of the hierarchical content node structure, provide the content item of the second content node as the candidate for display on the user device.

19. A non-transitory computer-readable storage medium comprising processor executable instructions for nodular content serving via a computer network, the instructions comprising instructions to:
receive a request for a content item, the request including a first attribute and a second attribute;
identify, in a memory element, a hierarchical content node structure set up by a content provider, the hierarchical content node structure comprising a first content node and a second content node, the second content node inheriting distribution parameters of the first content node;
determine, at content serving time, using real-time dynamic feed data from the content provider, a value for a variable distribution parameter of the second content node;
modify, based on the value, the variable distribution parameter of the second content node to generate a modified variable distribution parameter;
identify a first distribution parameter of the first content node, the first distribution parameter including a positive parameter and a negative parameter;
match the first distribution parameter of the first content node with the first attribute of the request based on the first attribute of the request including the positive parameter and not including the negative parameter;
identify a second distribution parameter of the second content node, the second content node including the negative parameter inherited from the first content node and the modified variable distribution parameter;
responsive to matching the first content node, match, the second distribution parameter of the second content node with the second attribute of the request based on the second attribute of the request not including the negative parameter inherited from the first content node; and
use the modified variable distribution parameter to provide a content item of the second content node as a candidate for display on a user device.

20. The non-transitory computer readable storage medium of claim 19, wherein the instructions further comprise instructions to:
compare the positive parameter with a second positive parameter of the second content node to determine that the positive parameter and the second positive parameter correspond to a same parameter type; and
override, for the second content node, the positive parameter with the second positive parameter of the second content node.
